(19) United States
(12) Patent Application Publication
(10) Pub. No.: US 2010/0051612 A1
(43) Pub. Date: Mar. 4, 2010

(54) MICROWAVE HEATER AND METHOD OF HEATING

(76) Inventors: Hans Magnus Fagrell, Uppsala (SE); Ian Christopher Ray, Danderyd (SE)

Correspondence Address: DEAN D. SMALL;THE SMALL PATENT LAW GROUP LLP, 225 S. MERAMEC, STE. 725T, ST. LOUIS, MO, 63105, US

(21) Appl. No.: 12/202,113

(22) Filed: Aug. 29, 2008

(51) Int. Cl. H05B 6/72

(52) U.S. Cl. 219/748

(57) ABSTRACT

A microwave heater and method of heating are provided. The microwave heater includes a non-resonant enclosure and a continuous helical antenna within the non-resonant enclosure. The continuous helical antenna is configured to receive therein a load to be heated by microwaves radiated from the continuous helical antenna.

### BACKGROUND OF THE INVENTION

This invention relates generally to microwave heaters, and more particularly, to a microwave heater especially for heating reaction mixtures and components in a chemical reaction or transformation.

A microwave heater employs microwave radiation to heat an object. Microwave heaters may be used in many different applications ranging from home or personal use for heating foods, to commercial or industrial uses. Many of today's microwave heating devices suffer from uneven heating of the heated object due to the unevenness of the applied electromagnetic field, thereby causing a corresponding thermal unevenness in the heated object. Moreover, because of the uneven field distribution, it is very difficult to evenly heat a reaction vessel especially with a length substantially longer than the cross section of the vessel for example, batch or flow reactors that have a form where the length of the reactor is substantially longer than the cross section of the vessel. Accordingly, conventional microwave heaters are not able to be used in certain applications.

Most microwave heater designs use a magnetron as the microwave generator. These microwave heaters suffer from several drawbacks including having a fixed frequency and the need for complicated devices and mechanisms to provide effective tuning. Moreover, these devices are bulky and have high voltage requirements. Additionally, the signals generated by these devices are very noisy and include a lot of sidebands that results in a distorted signal. The devices are also complicated to control and cannot be controlled down to power levels close to zero.

Most of these known microwave heating systems are based on a resonant cavity design in which the load (i.e., the object to be microwave treated) is placed. A load is generally defined as the material (matter) that is purposely intended to absorb the radiated electromagnetic energy. The load can be in any aggregation state such as a solid, liquid or gas form. Two types of microwave heater designs are common and include either a single mode or multi mode microwave cavity. An applicator is a device for transferring electromagnetic energy from an antenna to a load (e.g., reaction vessel). A single mode cavity applicator is a resonant cavity that has dimensions so that only one frequency can resonate inside the cavity. A multi mode applicator is a resonant cavity that has dimensions such that multiple frequencies can resonate inside the cavity. Both types of designs have a very pronounced mode or electromagnetic pattern with hot and cold spots in a repeating pattern. A mode pattern is an electric field pattern established by resonant frequencies inside a cavity. For example, with a commonly used microwave frequency, such as 2.45 GHz, the distance between two consecutive maximum heating areas is approximately 12.4 cm in a single mode applicator. Because the electric field has a sinusoidal shape between the maxima, the heating effect decreases rapidly outside the maxima. Moreover, the electromagnetic field distribution is very dependent on the size, shape and dielectric properties of the load in a resonant applicator. Thus, a large variation in heating efficiency and distribution may result depending on the load volume and size when using the same applicator.

Due to the nature of the resonant applicator, the resonant applicator structure must have a certain dimension to function properly. For commonly used frequencies such as 2.45 GHz, the dimensions result in typically bulky applicators and microwave heating systems with a relatively large cavity size compared to the load. For example, a typical multimode cavity applicator has a dimension of about 300 millimeters (mm)×300 mm×200 mm and a single mode applicator has a typical dimension for a rectangular applicator that is 43 mm×86 mm, using 2.45 GHz as a microwave frequency. In many modern applications, size is an important factor, and more particularly, reduction in size is very desirable. For example, in Positron Emission Tomography (PET) chemistry applications, there is a very limited space inside the hot cell where radio labels (e.g., radioactive molecule that are used to tag another molecule) are produced. PET is a radionuclide imaging technology based on determining the position of where a positron comes to rest and annihilates with an electron causing two gamma ray photons to be released and detected tomographically. A hot cell is a lead shielded compartment where radioactive reactions are carried out.

Additionally, portable or handheld devices should be compact to facilitate transportation and ease of use. Small compact devices are also desirable for automation of chemical reactions where the applicator is a subsystem in a larger system. In many applications it is desirable to replace electrical heaters with microwave heaters where the replaced electrical heater is substantially smaller than current bulky microwave heaters. Also, electrical heaters heat the surrounding environment, whereas microwave heaters only heat the object (load) to be heated. Small size in general is favorable in today's laboratories where bench space is a scarce and expensive resource.

Thus, most conventional microwave heaters used for chemical applications are large, complicated in design, expensive and moreover do not produce an even electromagnetic field in the load. Accordingly, the instrumentation for controlling these microwave heaters is typically complex and expensive to manufacture, particularly in mass market quantities.

### BRIEF DESCRIPTION OF THE INVENTION

In accordance with one embodiment, a microwave heating system is provided that includes a non-resonant enclosure and a continuous helical antenna within the non-resonant enclosure. The continuous helical antenna is configured to receive therein a load to be heated by microwaves radiated from the continuous helical antenna.

In accordance with another embodiment, a microwave heating system is provided that includes a non-resonant enclosure and a resonant antenna within the enclosure formed from a single continuous coil. The single continuous coil has a length greater than a diameter thereof.

In accordance with yet another embodiment, a method for heating a load with microwaves is provided. The method includes forming a continuous coil in a toroidal shape to define an antenna for generating an electromagnetic field therein and configuring the continuous coil to generate the electromagnetic field within a non-resonant structure to heat a load using microwaves.

### BRIEF DESCRIPTION OF THE DRAWINGS

FIG. 1 is a drawing of a basic microwave heating system formed in accordance with an embodiment of the invention.

FIG. 2 is a drawing of a basic microwave heating system formed in accordance with an embodiment of the invention using a balanced antenna

FIG. 3 is a drawing of a microwave heating system having a supporting structure formed in accordance with an embodiment of the invention.

FIG. 4 is a side sectional view of a microwave heating system formed in accordance with another embodiment of the invention.

FIG. 5 is a side sectional view of a microwave heating system formed in accordance with another embodiment of the invention having a moving load.

FIG. 6 is a side sectional view of a microwave heating system formed in accordance with another embodiment of the invention.

FIG. 7 is a top elevation view of the microwave heating system of FIG. 6.

FIG. 8 is a side sectional view of a microwave heating system formed in accordance with another embodiment of the invention.

FIG. 9 is a top elevation view of the microwave heating system of FIG. 8.

FIG. 10 is a perspective view of a microwave heating system formed in accordance with an embodiment of the invention.

FIG. 11 is a back plane elevation view of a microwave generator of the microwave heating system of FIG. 10.

FIG. 12 is a perspective view of an applicator of the microwave heating system of FIG. 10.

FIG. 13 is another perspective view of an applicator of the microwave heating system of FIG. 10.

FIG. 14 is drawing of a microwave system with capillary reaction vessels formed in accordance with an embodiment of the invention.

FIG. 15 is a drawing of a microwave system with capillary reaction vessels formed in accordance with another embodiment of the invention.

FIG. 16 is a drawing of a microwave system for flat load applications formed in accordance with an embodiment of the invention.

FIG. 17 is a side sectional view of the microwave system of FIG. 16.

FIG. 18 is a top plan view of the microwave system of FIG. 16.

FIG. 19 is a drawing of a microwave system with a u-tube flow cell formed in accordance with an embodiment of the invention.

FIG. 20 is a side sectional view of the microwave system of FIG. 19.

FIG. 21 is a top plan view of the microwave system of FIG. 19.

FIG. 22 is a drawing of a double u-tube flow cell formed in accordance with an embodiment of the invention.

FIG. 23 is a drawing of a coil type reaction vessel formed in accordance with an embodiment of the invention.

FIG. 24 is a drawing of a top plane view of FIG. 23.

FIG. 25 is a drawing of a microwave system with a tuning device formed in accordance with an embodiment of the invention.

FIG. 26 is a drawing of a microwave system with a tuning device formed in accordance with an embodiment of the invention.

FIG. 27 is a drawing of a microwave system with a tuning device formed in accordance with another embodiment of the invention.

FIG. 28 is a drawing of a microwave system with tuning devices and a control system formed in accordance with an embodiment of the invention.

FIG. 29 is a drawing of a microwave system with a high pressure reaction vessel formed in accordance with an embodiment of the invention.

FIG. 30 is a drawing of a microwave system with a capillary reaction vessel formed in accordance with another embodiment of the invention.

FIG. 31 is a drawing of a microwave system with a 3-port reaction vessel formed in accordance with an embodiment of the invention.

FIG. 32 is a drawing of a microwave system with analysis devices formed in accordance with an embodiment of the invention.

FIG. 33 is a cross-sectional view of the microwave system of FIG. 32 taken along the line A-A.

FIG. 34 is a drawing of a microwave heating system formed in accordance with another embodiment of the invention.

FIG. 35 is a drawing of a microwave heating system formed in accordance with another embodiment of the invention.

FIG. 36 is a drawing of a microwave heating system formed in accordance with another embodiment of the invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional or operational blocks of various embodiments, the functional or operational blocks are not necessarily indicative of the division between different components or hardware. Thus, for example, one or more of the functional or operational blocks (e.g., components) may be implemented in a single piece of hardware or multiple pieces of hardware. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It should be noted that although the various embodiments may be described in connection with uses for Positron Emission Tomography (PET) applications, or small scale chemistry applications, the systems and systems methods described herein are not limited to such applications. In particular, the various embodiments may be implemented in connection with heating any type of object or load in different applications, which may or may not be a medical application. For example, other applications include microwave treatment of tissues for diagnostic purposes or in situ hybridization reaction. Further applications include, for example, microwave treatment of tissues for diagnostic purposes, in situ hybridization reaction, thermo cycling in Polymerase Chain Reaction (PCR) reactions, capillary electrophoresis, organic or inorganic chemical reactions, Surface Plasmon Reactions (SPR), chemical binding reaction, digestion of biological material, etc.

Due to the possibility to design small applicators for low power systems the invention is especially suited for handheld battery powered systems. Such systems can be used for mobile field applications or where extremely small dimensions are needed. Examples can be handheld devices for analysis and diagnostic purposes carried in an ambulance, point of care and bed side applications in hospitals and homes, environmental analysis instruments etc.

In general, and as used herein, a microwave generator refers to any device that generates microwaves providing enough power at any given frequency sufficient for the chosen application. The device can also include all the necessary hardware and software for controlling the power, frequency and waveform for any given application. Examples of hardware and software include, but are not limited to: circulators, directional couplers, dummy loads, power sensors, pressure sensors, temperature sensors, microprocessors, control and optimization algorithms, etc. The components also can be either discrete or integrated or a combination thereof.

Exemplary embodiments of the present invention include a microwave heating system. The microwave heating system in the various embodiments is generally a device operating in microwave frequencies that is capable of heating an object or load by applying microwaves thereto. The object or load can be any type of object, substance or structure. In some embodiments, the microwave heating system may be used to heat reaction mixtures and components in a chemical reaction or transformation including both organic and inorganic reactions (e.g., heating solvents to produce radiopharmaceuticals, such as Gallium-68 chemistry solvents). It should be noted that the object or load can be of a stationary nature, such as a batch reaction in an open ended or close ended reaction vial or performed as a flow reaction with a continuous moving or flowing object or load within the vial or other container. The flow or movement of the object or load can also be intermittent.

It should be noted that although the various embodiments may be described in connection with specific component parts, variations and modification are contemplated. For example, microwave generators of the various embodiments may be implemented in different configurations, for example, as a semiconductor based microwave generator.

In general, various embodiments of the invention provide a microwave heater having on a non-resonant enclosure with a resonant antenna inside the enclosure. The enclosure has a transverse physical dimension such that the enclosure is at a frequency cut-off at a selected frequency and does not propagate electromagnetic energy. The antenna is dimensioned to be at resonance at the selected frequency. During heating of the load, the dielectric properties of the load change with a change in load temperature, thus implying the resonant frequency of the load will change. A change in resonant frequency changes the overall efficiency of the heating system. In order to maintain a good efficiency the system can be equipped with one or several tuning devices as described in more detail herein. By changing, for example, the Resistive/Inductive/Capacitive (R/L/C) characteristics of the tuning device, the antenna can be made to change its resonant properties and thereby change the efficiency of the heating system. A tuning device as referred to herein is generally a network containing either passive or active components that attempts to match the impedance of the active device to a transmission line. By monitoring, for example, the reflected power or the temperature of the load and using that as a feedback signal to the tuning device, the antenna can be tuned to optimize the heating efficiency of the system.

It should be noted that other tuning methods may be employed and are contemplated herein. For example, another way of tuning the system is to change the frequency of the microwaves generated by the microwave generator. By changing the frequency the antenna can be tuned to be resonant at any given condition or combination of load, antenna and enclosure. The frequency can be changed manually by changing the frequency control signal to a microwave generator. The change can be performed manually by an operator based on input from any information generated or observed in or on the heating system. Such information can be any visible changes of the load, indications from connected measurement devices such as volt meters, ampere meters, temperature sensors, pressure sensors, pH, conductivity sensor, fluoresces monitor, chemo luminescence, UV, IR/VIS, power meters etc. The frequency change can also be made automatically based on the same signals and input as from the manual methods mentioned described above.

Furthermore, a computer program can be used to optimize the performance of the heating system based on the same signals and input. The performance characteristic to optimize can be, for example, maximum power efficiency, heating rate, temperature stability, pressure, etc. The control and optimization can be performed by a controller as described herein. The controller can be an integrated part of the heating system or a separate device such as a PC, microcontroller, PLC system etc.

At least one technical effect of the various embodiments is generating more uniform electric fields using a non-resonant structure. The resonant antenna also can be designed to generate more even field distribution over the entire object or load without hot or cold spots (regions).

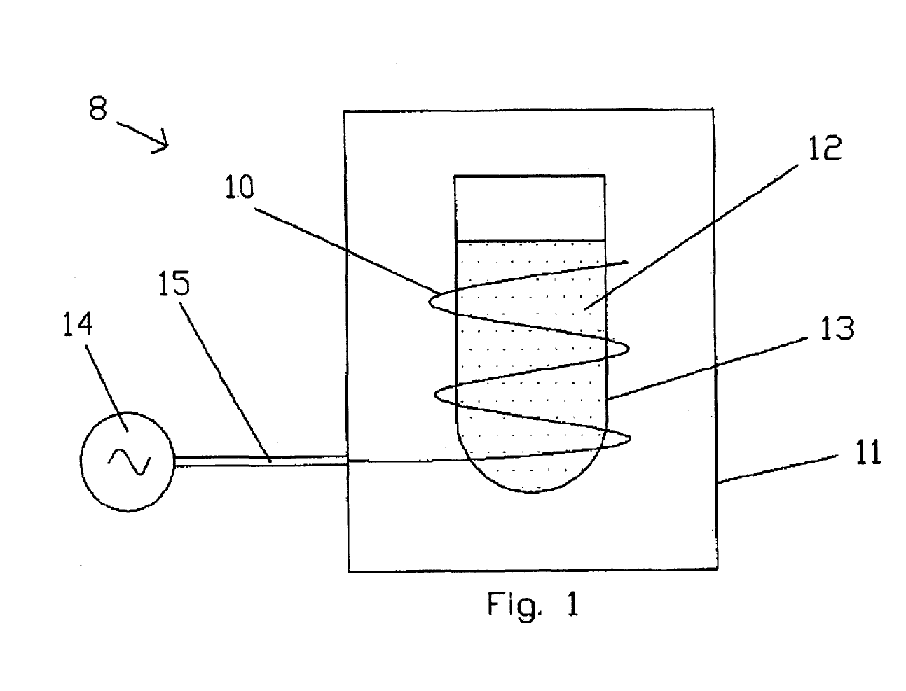

With reference now to the Figures, and as shown in FIG. 1, various embodiments of the invention provide a microwave heating system 8 that includes a non-resonant enclosure 11 and a resonant antenna 10 shaped as a helical or spiral antenna structure surrounding a reaction vessel 13 that may contain a load 12 (e.g., chemical mixture). The non-resonant enclosure 11 may have different dimension and may be formed from different materials as described herein.

The antenna 10 is connected to a microwave source 14 (e.g., microwave generator) via a transmission line 15, for example, a coaxial cable. The non-resonant enclosure 11 may be configured to be non-resonant by selecting dimensions to fulfill cut-off conditions for a selected frequency as described in more detail herein. The antenna 10 is made resonant by providing a length of the antenna that corresponds to the resonant conditions or by using a tuning device. Accordingly, the antenna 10 surrounds the load 12 partly or completely and that the total axial length of a coil that forms the antenna 10 is greater than (e.g., two times) the diameter of the coil structure that forms the antenna 10.

It should be noted that when the term resonant or resonance is used herein with respect to an antenna, the term generally refers to an antenna having a resonant component. The resonant component can very during the heating process and between different loads and run conditions. The amplitude of the resonant component can very from close to zero to 100%. As long as the antenna has a resonant component, a certain amount of energy will be radiated from the antenna and transferred to the load. It should be noted that resonant or resonance does not mean that the resonant conditions have to be at a maximum or near the maximum during any period of the process. It is sufficient to have a resonant component in the antenna. The total energy transferred to the load will be a function of the efficiency and the amount of power applied to the antenna. Many different applications, some of which are described herein can be performed with a very low efficiency without losing microwave heating performance. Also, the field concentrating effect and even heating will remain even with a very low efficiency in the system.

The non-resonant enclosure 11 contains an electrically conducting surface and in the illustrated embodiment is cylindrical in profile. For example, the non-resonant enclosure 11 may form an electrically conducting cavity constructed from aluminum, copper, brass, semiconducting material or a combination of materials, etc. However, it should be noted that other materials may be used. Also, it should be noted that the non-resonant enclosure 11 may have a different shaped profile other than cylindrical, for example, spherical, elliptical, cubic, triangular, rectangular etc. The non-resonant enclosure 11 may be shaped and sized based on and configured to receive therein a complementary shaped load holder, for example, a reaction vial 13, which may be removably received therein or permanently secured therein. It should be noted that the various embodiments also are not limited to a reaction vial 13, but a container or structure may be provided that is of any type that can receive therein or on its surface a fluid or other object. For example, instead of a reaction vial 13, a bulb, tube, a capillary structure, a thin film substrate, glass slab, microscope slide, micro titer plate, micro fluidic devices, micro arrays, micro fabricated structures, etc. may be provided.

Moreover, the cut-off frequency for the non-resonant enclosure 11 in one embodiment is determined by the radius of the non-resonant enclosure 11. Accordingly, the radius is selected to be small enough to prevent the propagation of certain microwaves, for example, 2.45 GHz microwaves.

In the various embodiments, the antenna 10 is configured as a one wavelength antenna that is curved around the reaction vessel 13 to form a closed relation to the load 10, and in particular, to form an antenna with helical properties. Accordingly, in operation, a very broadband frequency and a circularly polarized electric field that couples and interacts with the load 12 in many places is provided. It should be noted that the antenna can have any length corresponding to any number of wavelengths or fractions thereof, as long as the length fulfills resonant conditions.

The antenna 10 in various embodiments is formed from a copper wire dimensioned to sustain the required output power. For example, in one embodiment, the antenna 10 may be formed from two millimeter (2 mm) thick wire, such as copper, gold, brass, aluminum, metal coated structures with a core of non conducting materials such as polymers, semiconducting materials or combination of mentioned materials. The wire is provided such that the wire is wide enough to sustain an electric field generated by, for example, 100 watts to 500 watts of power or more. The antenna can also be formed from a printed circuit board arranged around the load. The printed circuit board can be of a flexible type that can be formed around the load. The antenna can also be stereo lithographic printed on a substrate and arranged around the load.

The antenna 10 that forms a curvature or partial helix around the load 12 that is inside the reaction vessel 13 has typically a minimum of one turn, but in the various embodiments can have two to ten turns. However, the antenna can have any number of turns as long as the resonant conditions are sustained as described herein. The pitch of the antenna 10 is adjusted such that the inductive reactance is close to the load impedance as described in more detail herein. The pitch can vary over the length of the antenna, linearly or non-linearly. Because the antenna 10 has a dominant inductive reactance, the frequency response of the structure is broadband in nature. In one embodiment, the reaction vessel 13 has a narrow geometric profile. However, it should be noted that the load 12 can be many times longer than the antenna 10 and the various embodiments can still achieve uniform and even heating.

In operation, the reaction vessel 13 is placed or secured inside or partially inside the helical antenna 10 and accordingly the electric field is strengthened and becomes more concentrated inside the helix rather than outside the helix, resulting in an intensified electric field inside the reaction vessel 13. The electric field propagated from the antenna 10 is also contained within the conductive enclosure, namely the non-resonant enclosure 11. It should be noted that the various embodiments operate using only one microwave source 14 and only one antenna 10, which in the various embodiments is either a single ended continuous helical antenna or a balanced antenna. Moreover, because the antenna 10 is somewhat broadband, the antenna has a moderately low Q value. Accordingly, the antenna 10 can resonate over a wide band of frequencies and is not highly resonant on just one frequency. Thus, the configuration of the microwave heating system 8 is less dependent on the load 12 to be heated.

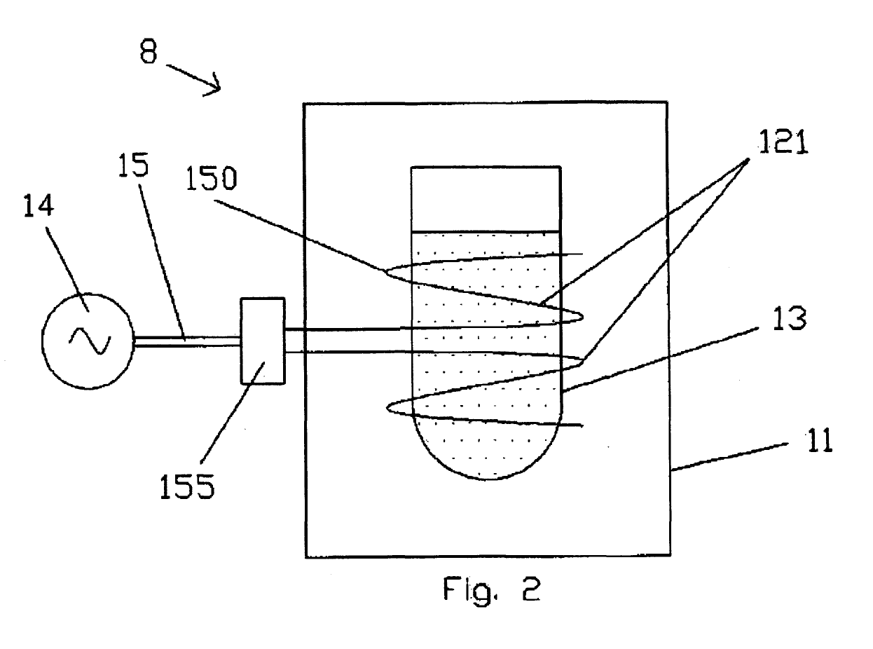

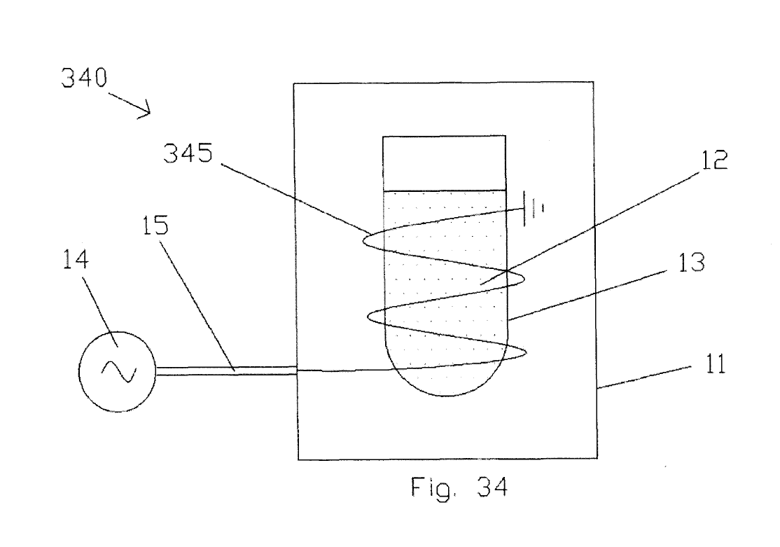

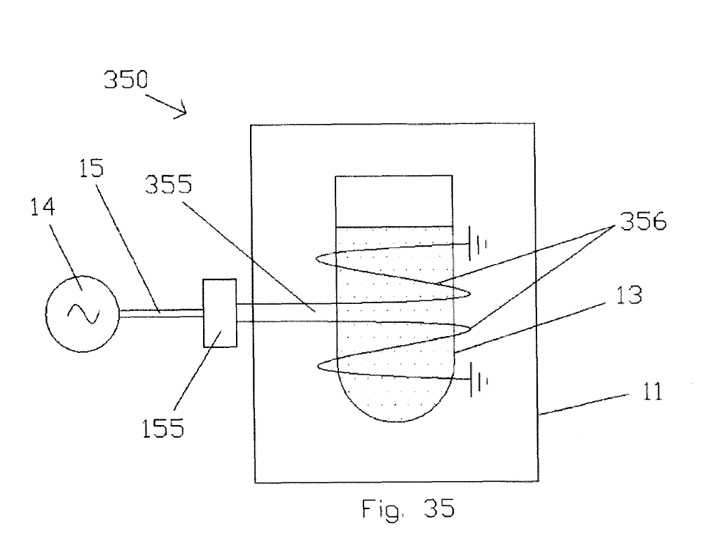

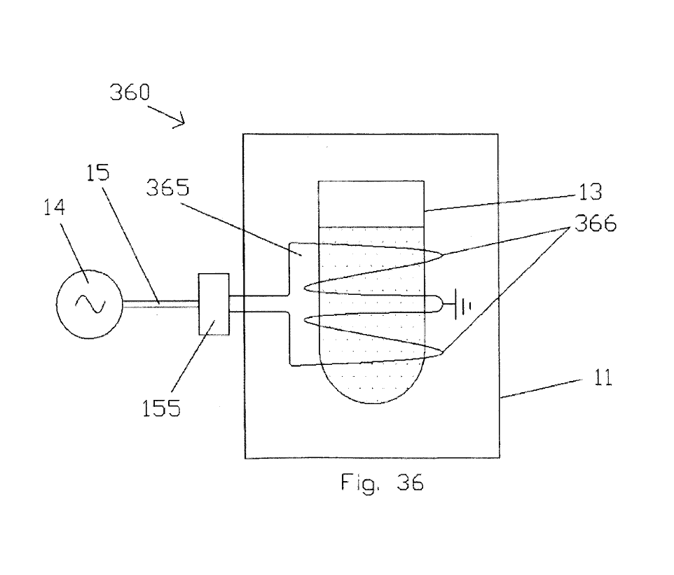

It should be noted the antenna type can be either a single ended open antenna fed from one end as shown in FIG. 1, or a single ended closed loop antenna where one end can be connected to earth, as shown in FIG. 34. The antenna can also be an open balanced antenna that is fed symmetrically in the middle using a balance-to-unbalance transformer (balun), as shown in FIG. 2; or a closed loop balanced antenna fed from a midpoint of the antenna with the two outer endpoint of the antenna connected to earth, as shown in FIG. 35; or fed from the two outer end points of the antenna and connected to earth at the midpoint of the antenna as shown in FIG. 36. A balun as used herein refers to a device that converts a single-ended transmission line to a symmetrical pair of transmission lines having exactly the same properties and symmetrical to ground. A single ended antenna is a device as used herein refers to an antenna fed by a single transmission line and usually fed at one end. A balance antenna as used herein refers to an antenna that is fed at the center or at the two endpoints by two symmetrical transmission lines with respect to ground. It should be noted that in all described embodiments, all described types of antenna can be used even if only one type is described in a specific embodiment.

The characteristics of the antenna and thereby the generated electrical field can be adjusted (tailor made) to surround the load by combining certain values of the antenna parameters such as the pitch, helical diameter, wire diameter, number of turns, total uncoiled antenna length and the coiled antenna length. By changing these parameters the electrical field can, for example, be evenly distributed and concentrated to the middle of the coil where the load is placed. Another way of changing the electric field distribution in the applicator is to change the dimensions of the non-resonant enclosure.

Referring again to FIG. 1, the pitch, radius and length of the helical antenna 10 determine an impedance and center frequency for the antenna 10. Accordingly, depending upon the application or use for the microwave heating system 8, the pitch, radius and/or length may be adjusted accordingly, for example, to provide desirable, required or optimum dimensions. For example, the unwound length of the antenna 10 may be less than one wavelength, equal to one wavelength or greater than one wavelength. The pitch can vary over the length of the coil, linearly or nonlinearly. The diameter of the antenna can also vary over the coil length. The shape of the coil can have any geometric shape such as elliptic, circular square, rectangular, triangular, octahedral, polyhedral etc,

In the various embodiments, the antenna 10 is a single ended continuous antenna or a balanced antenna that covers part of or the entire load 12. However, it should be noted that the load 12 in some embodiments may extend beyond the ends of the antenna 10. The length of the coil forming the antenna 10 is typically one electrical wavelength in air. Accordingly, for microwaves at 2,45 GHz, a single wavelength in air is approximately 12.4 centimeters and the antenna is formed having a length of 12.4 centimeters. Thus, a single unipole helical antenna 10 curved around the load 12 is provided that generates an electric field inward toward the load 12. For example, the antenna 10 may be configured to be curved around a load 12 of about 0.2 milliliters to about 40 milliliters or more. Accordingly, the field is concentrated mainly inside the coil and to a lesser extent outside the coil.

FIG. 2 shows the same type of applicator as used in FIG. 1 with an open balanced antenna 150 instead of a single ended antenna. A balanced antenna that is fed from an unbalanced source must be connected via a balance-to-unbalance transformer 155 (balun). A balanced antenna is constructed symmetrically with respect to the feed point and preserves symmetry with respect to ground thus avoiding unbalanced currents and unwanted radiation in the transmission feed line. This ensures all energy is radiated more efficiently from the antenna. The balun can be physically placed anywhere between the microwave source 14 and the beginning of the antenna 150. The balanced antenna part 121 can have the same design, dimensions and features as the herein described single ended antennas.

However, other types of antennas may be used. For example, as shown in FIG. 34, a system 340 includes the same type of applicator as used in FIG. 1, but with a closed loop single ended fed antenna 345 where the outer end of the antenna is connected to earth. As another example, as shown in FIG. 35, a system 350 includes the same type of applicator as used in FIG. 2, but with a closed loop balanced antenna 355 where the two antenna legs 356 are connected to earth. The antenna 355 is fed in the center and connected to earth at the outer points of the antenna. As still another example, as shown in FIG. 36, a system 360 includes the same type of applicator as used in FIG. 35, but with a closed loop balanced antenna 365 where the two antenna legs 366 are connected to earth. The antenna 366 is fed from the outer points of the antenna and connected to earth at the center of the antenna.

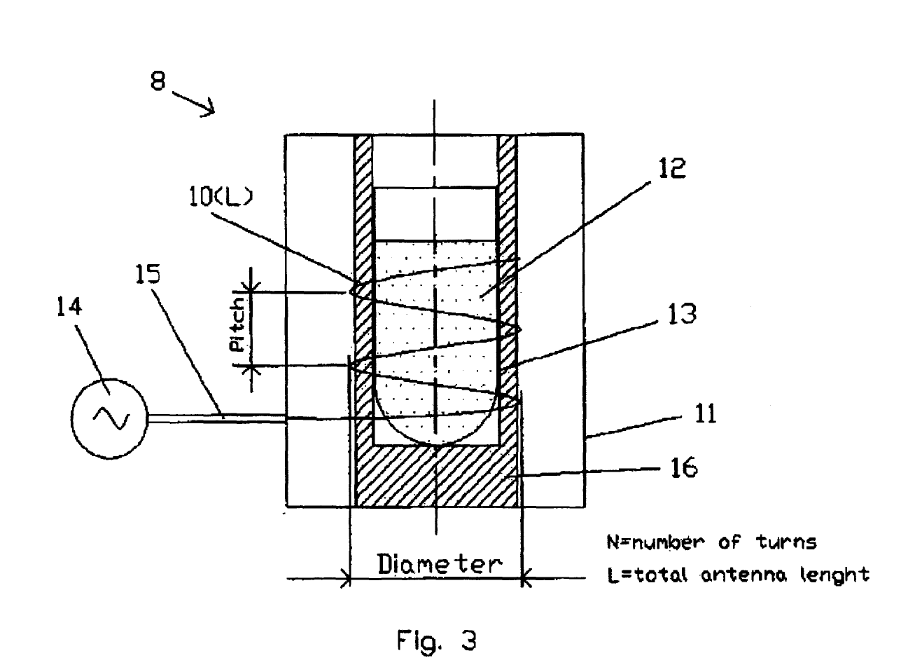

The various embodiments also may provide a supporting structure 16 as shown in FIG. 3. The supporting structure 16 supports and maintains the position of the reaction vessel 13 within the antenna 10. The supporting structure 16 may be formed of any suitable microwave transparent or microwave semi-transparent material, for example, a polytetrafluoroethylene (PTFE) material, such as Teflon. Also, the microwave heating system 8 can be made non-resonant by configuring the dimensions of the enclosure 11 to achieve frequency cut-off conditions as described herein. Alternatively or optionally, to avoid resonance in the enclosure 11, an inner surface can be coated with a microwave absorbing material or have an absorbing structure.

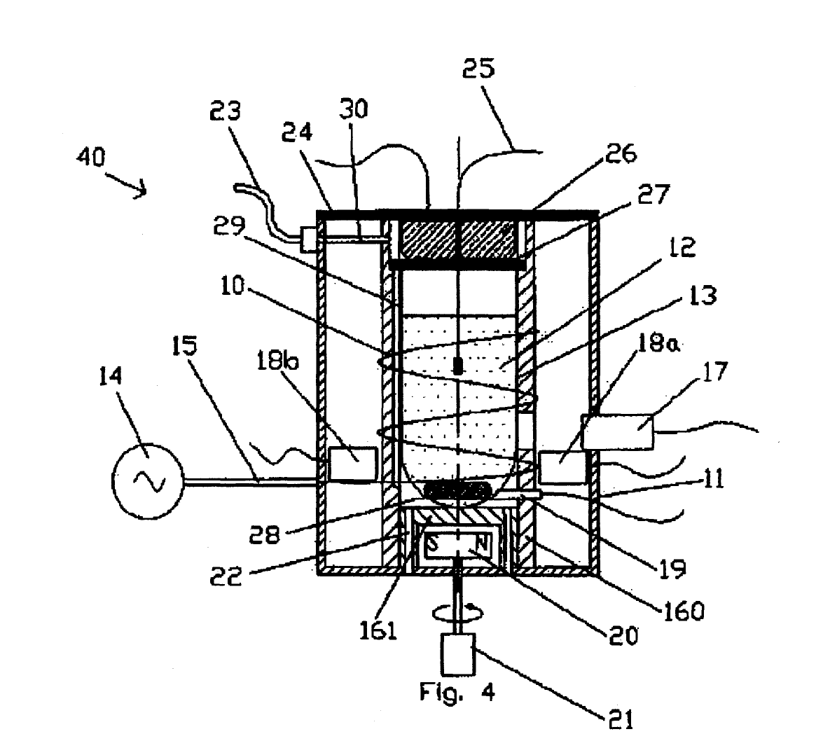

Modifications and variations to the various embodiments may be made. For example, a microwave heating system 40 as shown in FIG. 4 may be provided. It should be noted that like numerals represent like or similar parts throughout the various embodiments. In this embodiment, the microwave source 14 is a microwave generator that includes a semiconductor based amplifier (not shown) with variable frequency and power. The transmission line 15 from the microwave source 14 to the microwave applicator that includes the enclosure 11 and components therein, may be a coaxial cable, but can be any type of transmission line or device that communicates or transfers the microwaves or microwave signals from the microwave source 14 to the applicator, and in particular, to the antenna 10. The supporting structure 160 and 161 is configured to maintain the position of the reaction vial 13 and the antenna 10, for example, maintain the reaction vial 13 or a portion thereof within the antenna 10.

In this embodiment, a temperature sensing device 17, for example, an infrared (IR) temperature sensing device is provided and that may be coupled into the enclosure 11. The temperature sensing device 17 measures the temperature, for example, on the surface of the reaction vial 13. Additionally, electromagnets 18a and 18b are provided that operate to rotate a stirring bar 28 (e.g., horizontal magnetic bar at the bottom of the reaction vial 13) that can stir the load (e.g., chemical fluid) within the reaction vial 13. The electromagnets 18a and 18b may be driven in sequence using, for example, a stepper motor driver (not shown) to rotate the stirring bar 28. It should be noted that while only two electromagnets 18a and 18b are shown, in one embodiment there are four electromagnets to drive the stirring bar 28, with the two additional electromagnets in 90 degree relationship to the electromagnets 18a and 18b.

The microwave heating system 40 optionally may include an alternative temperature measuring device 19. For example, the temperature measuring device 19 may be a thermocouple that is coupled or maintained against the surface of the reaction vial 13 to measure the temperature thereof. Also, an alternative driver 20 for rotating the stirring bar 28 optionally may be provided. For example, the alternative driver 20 may comprise a permanent magnet rotated by an electric motor 21 that causes the stirring bar 28 to rotate.

One or more outlet channels 22 may provide a passageway from inside the enclosure 11 to outside the enclosure 11. The one or more channels 22 may be provided, for example, on a bottom of the enclosure 11 for venting or cooling of the air within the enclosure 11 surrounding the reaction vial 13. Inlet tubing 23 also may be provided for forcing air, for example, cooling air into the enclosure 11 through a channel 30. The inlet tubing 23 may be provided, for example, on a top or side surface of the enclosure 11 and connected to a source of cooling air (not shown) such as a cooling fan radiator or compressed air or any other type of cooling media.

The enclosure 11 also includes a cover or lid 24 to cover a top surface of the enclosure 11 to form a closed vessel comprising of enclosure 11 and cover 24 in which the reaction vial 13 is maintained. Accordingly, the reaction vial 13 is encompassed on all sides and maintained within the closed vessel. The supporting structure 160 may include one or more channels 29 along the side of the reaction vial 13 that allow the passage of cooling air, thereby defining cooling passages. The lid 24 can be connected to the enclosure 11 via a thread or other mechanical means to withstand high mechanical forces created by the internal pressure in the reaction vessel or inside the enclosure. The microwave heating system 40 also may include an internal temperature measuring device 25, for example, a thermocouple device, temperature probe, optical device, etc. to measure the temperature inside the reaction vial 13. The internal temperature measuring device 25 may be positioned inside the reaction vial 13 within the load 12. It should be noted that the temperatures measured by the different temperature measuring devices may be displayed on a screen associated with the measuring device (e.g., LCD screen).

A pressure sensor/load cell 26 also may be provided to measure the reaction force from a moving part (not shown) that may be provided in combination with a lid or cap 27 covering the reaction vial 13. The moving part may be, for example, a septum or plunger that moves outward or upward when the internal pressure within the reaction vial 13 increases and moves the opposite direction when the internal pressure decreases. It should be noted that the lid or cap 27 may be configured to be securely sealed to the reaction vial 13.

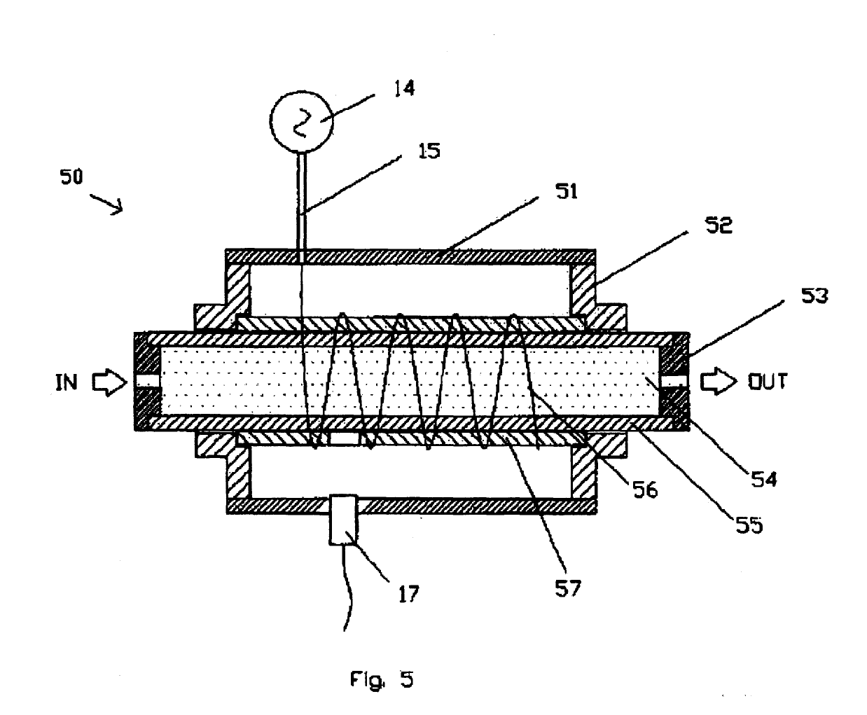

In another embodiment, and as another example, a microwave heating system 50 as shown in FIG. 5 may be provided. The microwave heating system 50 includes a metallic enclosure 51 illustrated as cylindrical. However, the metallic enclosure 51 may have any shape or size that fulfills the conditions for a non-resonant structure. Metallic end pieces 52 on axially opposite ends of the metallic enclosure 51 are configured to hold a supporting structure 57 within the metallic enclosure 51. The metallic end pieces 52 may be shaped having shoulders to engage the supporting structure 57. The supporting structure maintains the position of a reaction tube 55 within the enclosure 51 and relative to the antenna 56, which is a resonant antenna. The supporting structure 57 may be, for example, a PTFE cylinder with the antenna 56 surrounding (e.g., wrapped around) the supporting structure. The supporting structure 57 prevents contact of a load 54 with the wire coil forming the antenna 56. However, it should be noted that in this and other embodiments described herein, the supporting structures, for example, the supporting structure 57 may not be included and the reaction tube 55 provided directly within the antenna 56.

End caps 53 are provided on each end of the reaction tube 55 and include ports, for example, an inlet port and outlet port defining passageways to allow the load 54 to be heated by the microwave heating system 50 to be inserted and removed, for example, pumped in and out of the reaction tube 55. The load 54 may be, for example, a chemical reaction mixture or any substance that can be pumped in and out of the reaction tube 55. The embodiment shown in FIG. 5 can also be used for treating gases or mixtures of gases. For example, the embodiment of FIG. 5 may be used for treating of exhaust gases from combustion processes.

It should be noted that the reaction tube 55 may be constructed from a microwave transparent material or partially microwave transparent material such as glass, a PTFE material, etc. Also it should be noted that other component parts similar to the other embodiments may be provided, for example, the temperature sensing device 17. It should be noted that the antenna 10 can be exchanged to a balanced antenna.

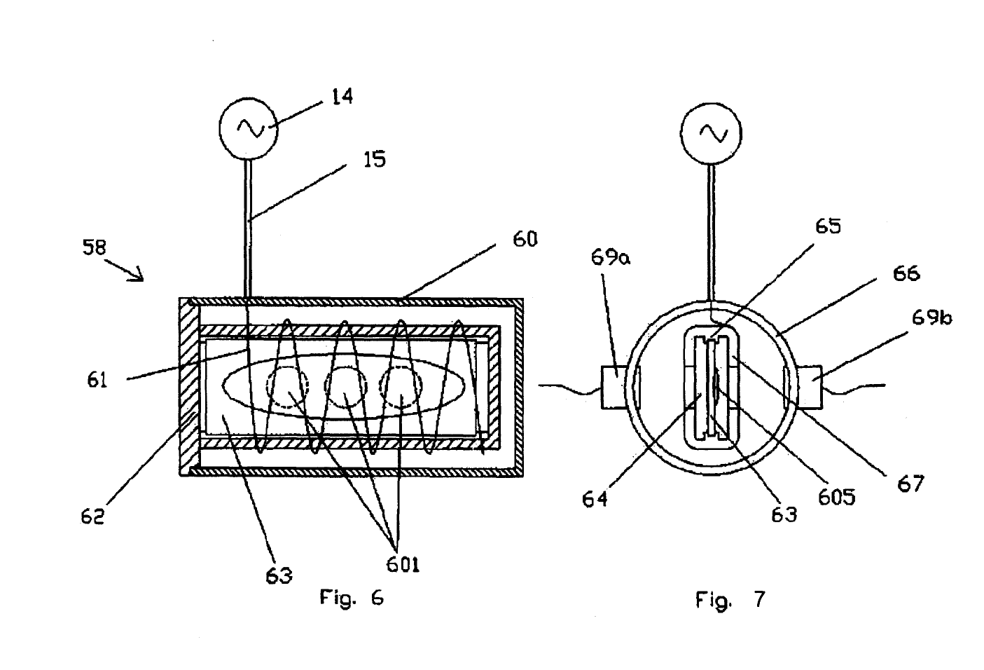

In another embodiment, and as another example, a microwave heating system 58 as shown in FIGS. 6 and 7 may be provided. The microwave heating system 58 includes a non-resonant enclosure 60 illustrated as cylindrical that is constructed of metal and having a resonant antenna 61 therein surrounding a supporting structure 67. However, the non-resonant enclosure 60 may have any shape or size that fulfills the conditions for a non-resonant structure.

A metallic lid 62 is provided to close the non-resonant enclosure 60. The metallic lid 62 may provide a pressure tight seal. In this embodiment, the object to be treated with microwaves, namely the load 605 is placed on a holding structure 63 that can be a glass slab. It should be noted that the slab may be made of any material. Moreover, the load 605 can be of any shape or size, for example, a shape and size that fits into or on the holding structure 63. The supporting structure 67 may be formed, for example, having a slot 65 therein for receiving the holding structure. The holding structure 63 can be, for example, a pre-made cassette and may have features such as built in channels for liquid flow and functions like valves, pumps, etc. as an integrated part of the holding structure. The cassette can be made for diagnostic, analytical or preparative purposes. The devices 69a and 69b can be any type of monitoring devices measuring or monitoring process parameters such as temperature, pressure, light scattering, etc. The devices 69a and 69b can be arranged in a way such that one is a transmitter and one is a receiver. The transmitter sends a signal that reflects, transmits, scatters, refracts or in any other way is affected by the load and the receiver receives the affected signal from the transmitter. The signals from both devices 69a and 69b can, for example, be compared using any computational device and algorithm to calculate a result. The result can be used to control the microwave heating system or generate an output signal used for diagnostic or analytic purposes. The transmitter and receiver can be in the same physical enclosure and need only access from one side of the load 605. The transmitted signal can be radiation of any type, for example, laser, Ultraviolet (UV), Infra Red (IR), x-ray, ultrasound, etc. The receiver can be any type of device that detects, for example the change in the transmitted signal caused by the microwave treatment of the load. The supporting structure 67 has a number of openings 601 to gain access to the load for the devices 69a and 69b. The devices 69a and 69b can be extended to form an array.

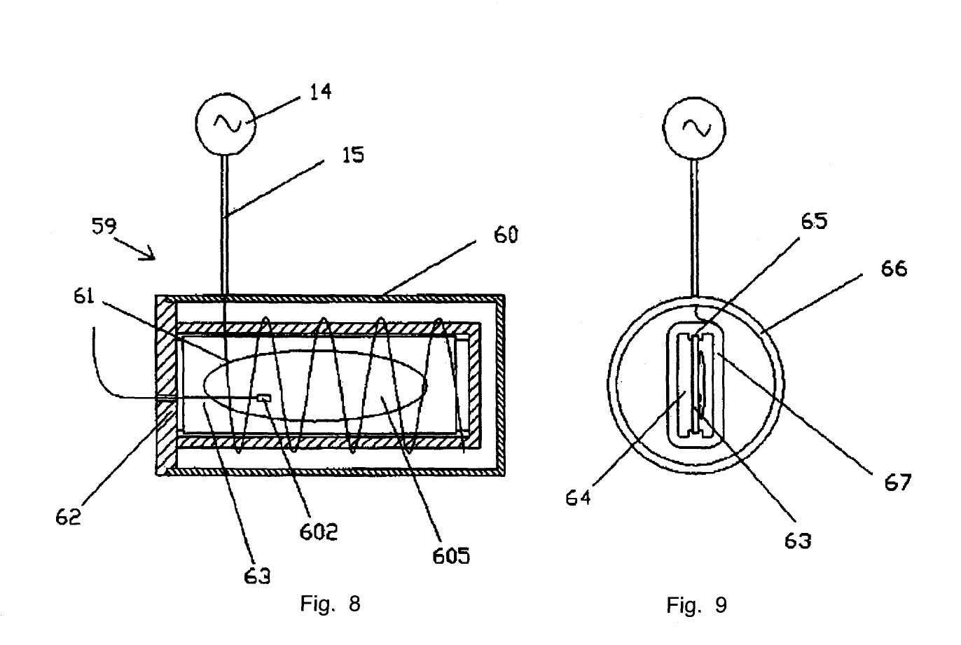

In another embodiment, and as another example, a microwave heating system 59 as shown in FIGS. 8 and 9 may be provided. The microwave heating system 59 includes a non-resonant enclosure 60 illustrated as cylindrical that is constructed of metal and having a resonant antenna 61 therein surrounding a supporting structure 67. However, the non-resonant enclosure 60 may have any shape or size that fulfills the conditions for a non-resonant structure.

A metallic lid 62 is provided to close the non-resonant enclosure 60. The metallic lid 62 may provide a pressure tight seal. In this embodiment, the load 605 is placed on or in a load holder 63. In this embodiment the load holder is a glass slab which the load is placed on to be treated by microwaves. It should be noted that the slab may be made of any material and have different features to hold the load. Moreover, the load 605 can be of any shape or size that fits on or in the load holder 63. The supporting structure 67 may be formed, for example, having a slot 65 therein for receiving the slab. Also, the supporting structure 67 can be filled with a liquid 64 such that the load 605 is submerged or partially submerged in the liquid. It should be noted that the liquid can be part of a reaction system where the liquid contains the reactant, catalyst etc. The liquid can be exchanged for a gas. A temperature measuring device 602 can be introduced to measure the temperature in or on the load 605. The load 605 and the holding structure 63 can be, for example, a pre-made cassette with built in channels for liquid flow and functions like valves, pumps etc as an integrated part of the 605. The cassette can be made for diagnostic, analytical or preparative purposes.

It also should be noted that the various metallic structures described herein may be formed of any type of metal or a composite thereof. For example, metals such as copper, aluminum, brass, steel, etc. or combinations or composites thereof may be used.

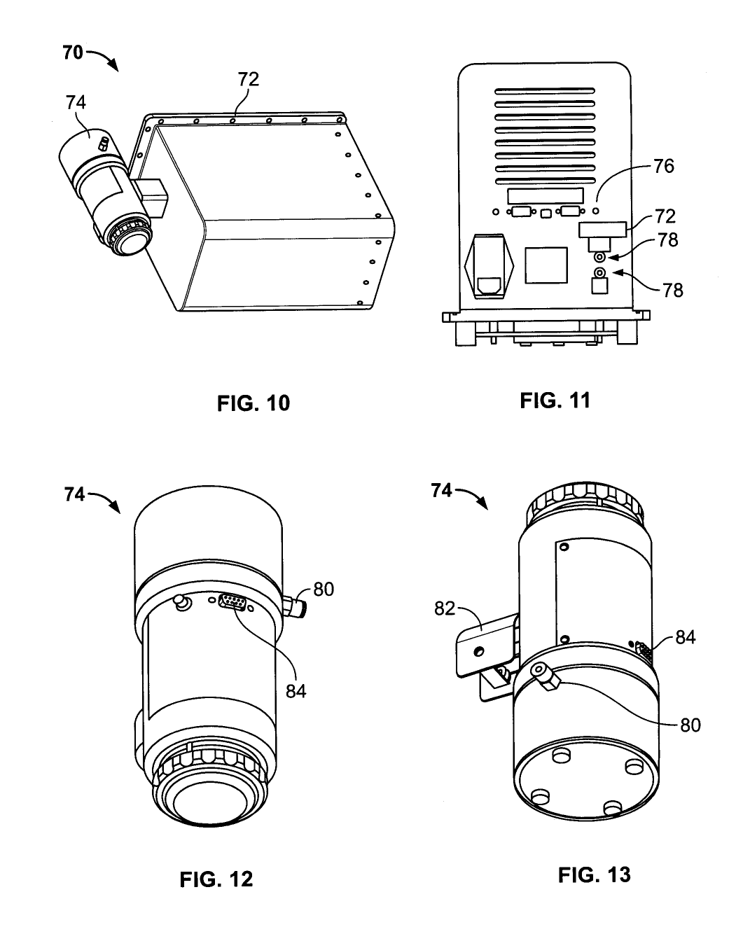

Accordingly, in various embodiments a microwave heating system 70 as shown in FIG. 10 includes a microwave generator 72 as shown in FIG. 11 and an applicator 74 as shown in FIGS. 12 and 13. The microwave generator 72 is configured to generate microwave signals to be emitted by a helical antenna constructed in accordance with the various embodiments and within the applicator 74. The microwave generator 72 may include one or more data connections 76 (e.g., serial or USB connections) and ports 78, for example, for connection to an air cooling system (not shown). It should be noted that the air cooling system may be any type of system capable of providing air. The outlet port 78 is connected to a port 80 on the applicator to provide air to the cooling system of the applicator 74. The applicator 74 is a non-resonant enclosure as described herein and includes a connector 82, for example, a coaxial connector to connect the antenna within the applicator 74 with a microwave source within the microwave generator 72. The applicator 74 also may include one or more data connections 84 (e.g., serial or USB connections).

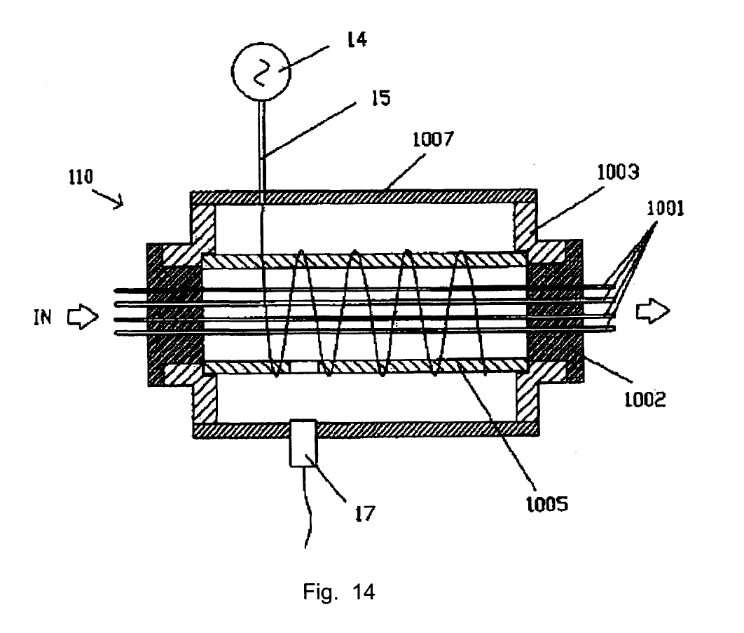

In another embodiment, as shown in FIG. 14, a microwave heating system 110 may be provided that includes capillaries 1001 as reaction vessels. The capillaries can be a single capillary or several capillaries in a tight bundle or in a more even or uneven spread out pattern inside a supporting structure 1005. The number of capillaries can range from one up to several thousand in a bundle. Two end pieces 1002 hold the capillaries in place and act also as a microwave barrier to prevent microwaves from reaching the surroundings. The structure 1003 holds the enclosure 1007 and with the end pieces 1002 together form a non resonant enclosure. The capillary can be made of either microwave transparent or non transparent material. The capillary can be coated on the outside or/and the inside surface to gain other physical or chemical properties. A non contact temperature measuring device 17 also may be provided. Alternatively, the temperature can be measured with a contacting device mounted on one or several of the capillaries. One application for this embodiment can be, for example, capillary electrophoresis.

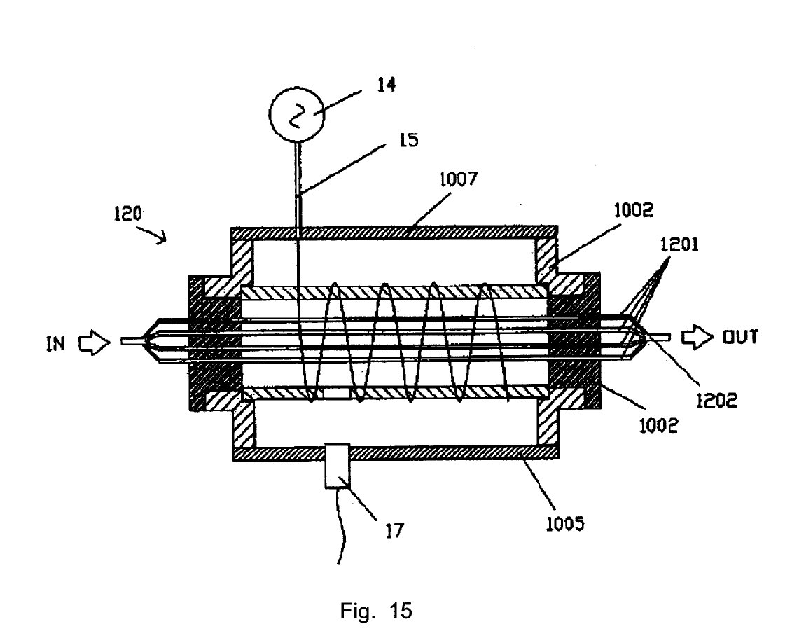

In yet another embodiment as shown in FIG. 15, a microwave heating system 120 is provided that includes several capillaries 1201 or tubes connected through a manifold 1202 to form a parallel structure within the applicator.

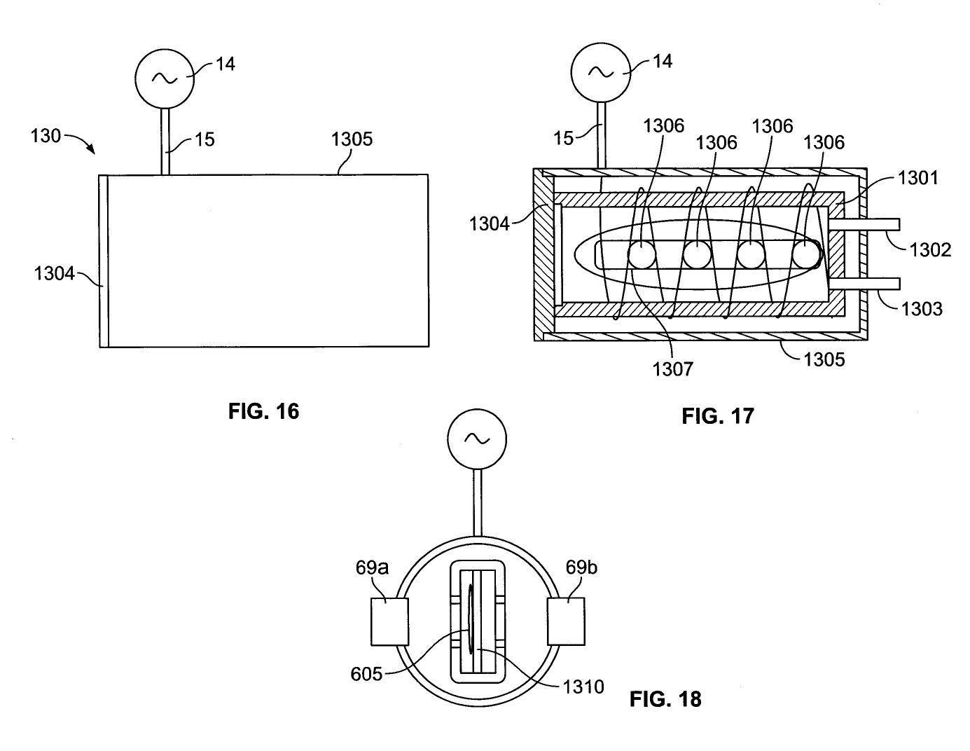

In yet another embodiment as shown in FIGS. 16 through 18, a microwave heating system 130 is provided wherein the supporting structure 1301 includes a fluid connection 1302 and 1303 to act as an inlet and outlet port for liquids and/or gases. FIG. 17 shows a cross-section of heating system 130. FIG. 18 shows a view from the left without the lid 1304 on. A pressure tight enclosure is formed by the enclosure 1305 and the lid 1304. The supporting structure 1301 includes a number of openings 1306 to gain access to the devices 69a and 69b to measure and monitor physical and/or chemical parameters on or in the load 605 placed on load holder 1310. The openings 1306 can alternatively be a continuous slot 1307 to enable a more continuous monitoring of the load 605 by making the devices 69a and 69b movable along the slot. The openings 1306 or the slot 1307 can be covered by a pressure tight material such as glass, quarts, quartz, silicone carbide, etc. to make the supporting structure 1301 pressure tight. The slot 1307 or the openings 1306 also can be removed to form a completely sealed or airtight structure.

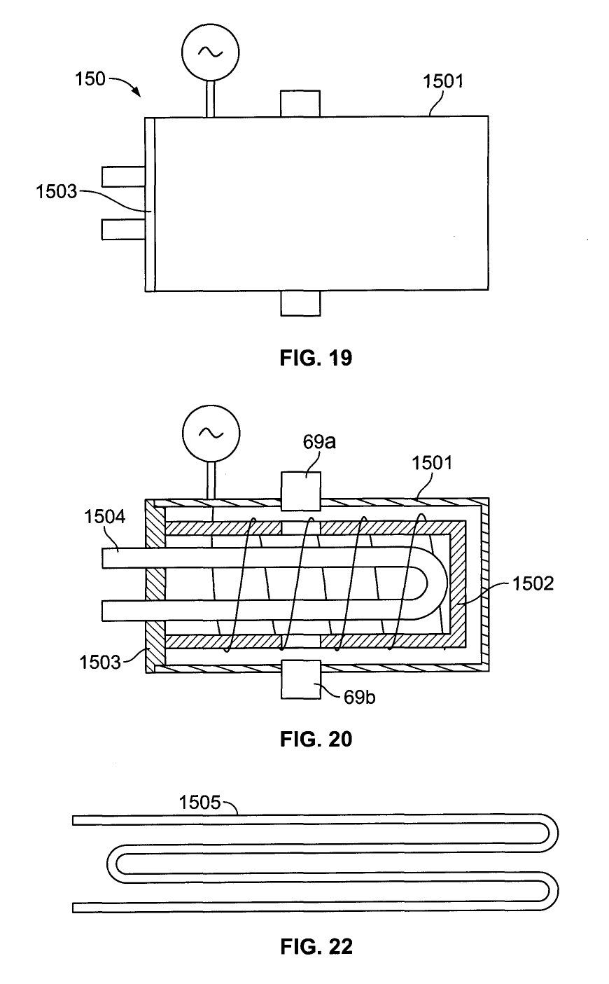

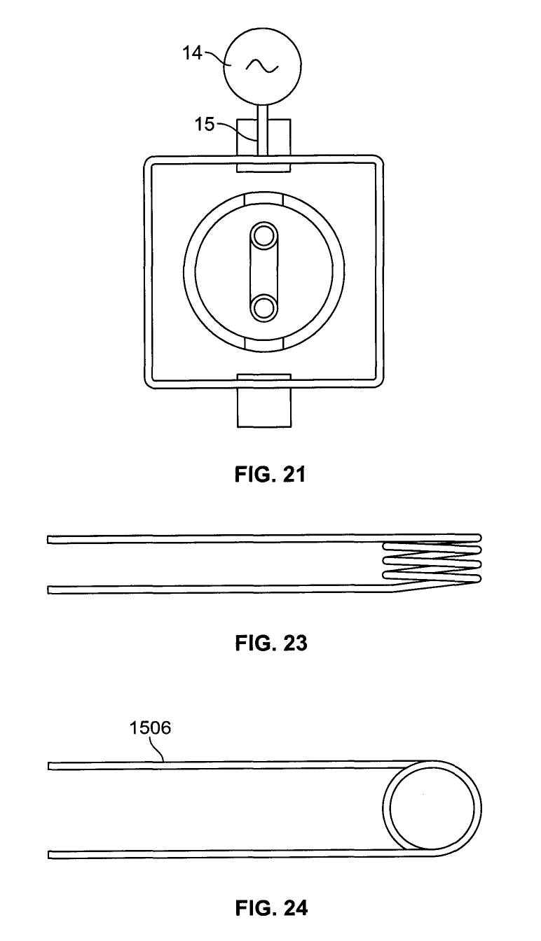

Another embodiment as shown in FIGS. 19 through 23 includes a microwave heating system 150 wherein different types of tube/capillary reaction vessels may be provided. FIG. 19 shows a u-tube reaction vessel microwave heating system 150. FIG. 20 shows a cross-section of the system 150 having a u-shaped reaction vessel 1504 inside the supporting structure 1502. The enclosure 1502 together with the lid 1503 forms a pressure tight non resonant enclosure. FIG. 21 shows a view without the lid 1503. FIG. 22 shows a meander type of reaction vessel. FIGS. 23 and 24 show a coil type reaction vessel. It should be noted that the inner diameter of the reaction vessels can be from a few micrometer to several centimeter or more.

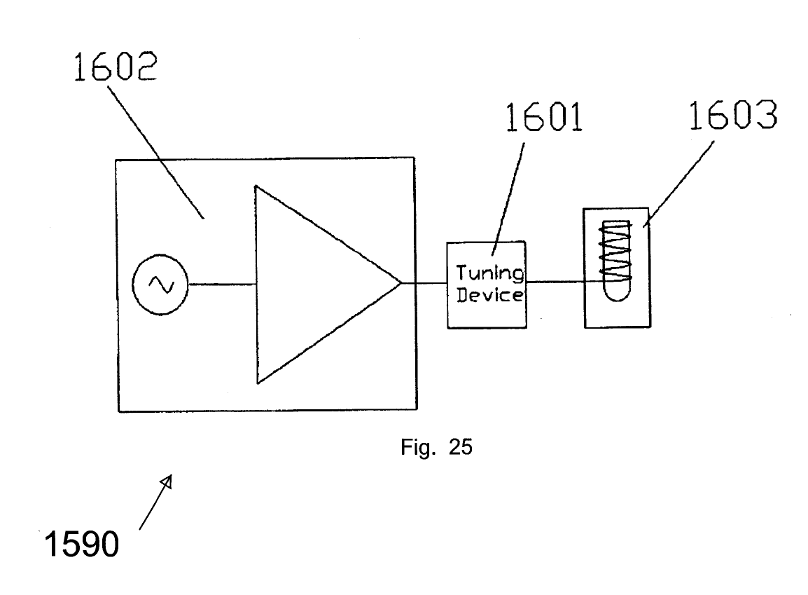

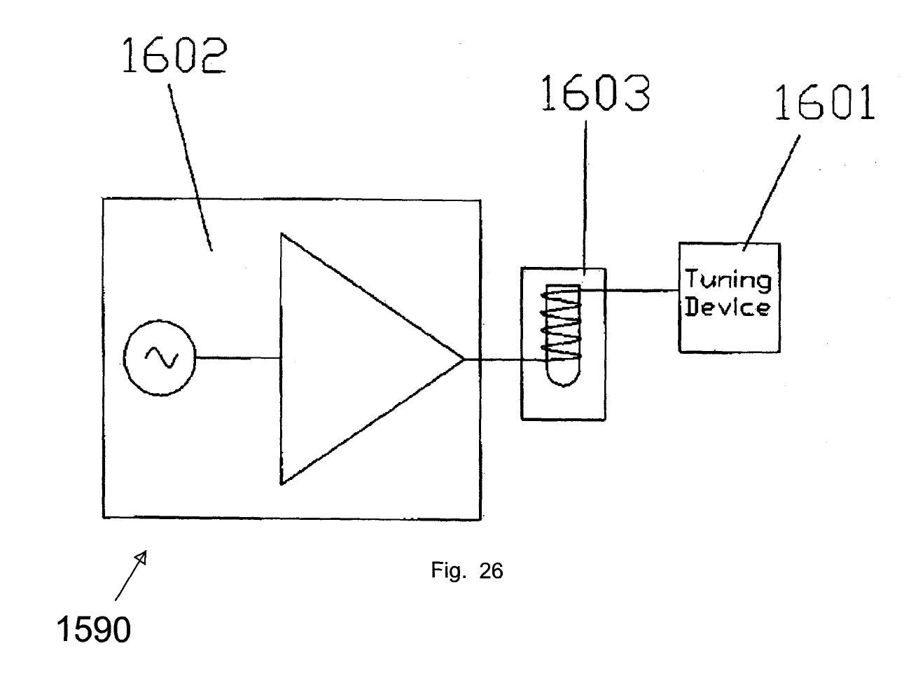

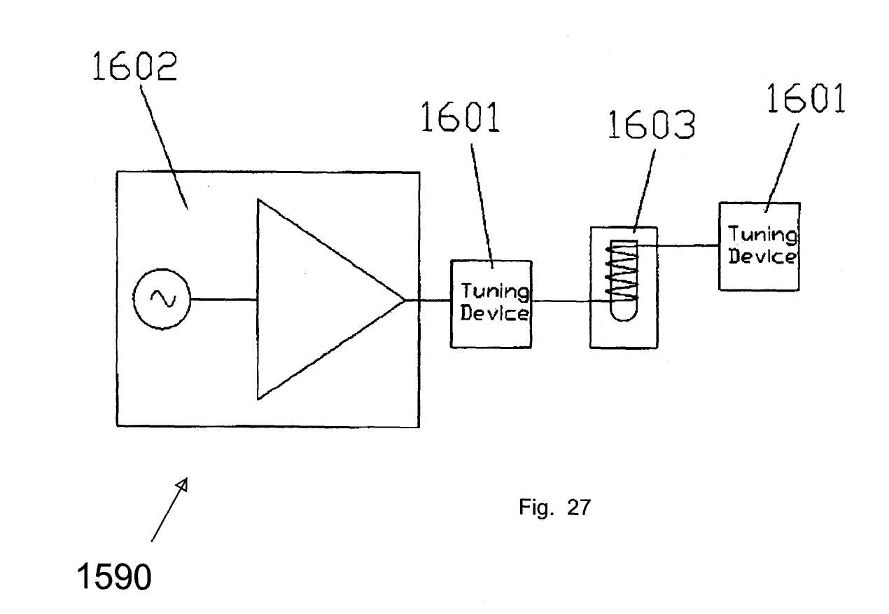

FIG. 25 shows a heating system 1590 with a tuning device 1601 between a microwave generator 1602 and an applicator 1603. The tuning device 1601 includes functions to change R-L-C (Resistive-Inductive-Capacitive) characteristics and thereby change the tuning of the heating system 1590. In this case, the tuning device 1601 is placed between the generator 1602 and the applicator 1603. However, as shown in FIGS. 26 and 27, the device or devices can be placed after the applicator 1603 or one before and one after the applicator 1603.

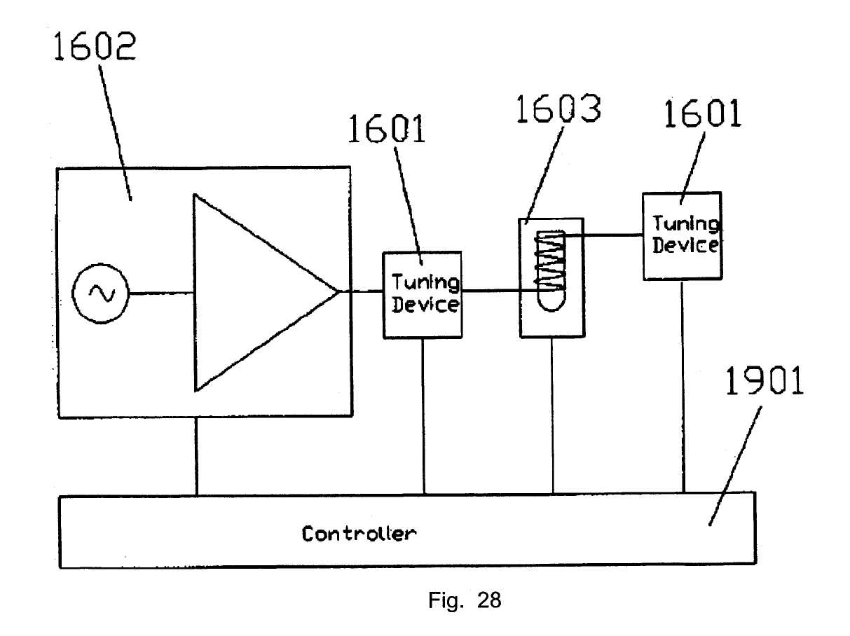

FIG. 28 shows a control system 1901 that can control the tuning devices described herein to optimize the performance of the heating systems described herein. The control system 1901 is controlled by control signals from, for example, a number of sensors and measuring devices in the system as described herein. This signal can be, for example, temperature, pressure, reflected power, etc. The control system 1901 can be, for example, a finite state machine or a feedback machine.

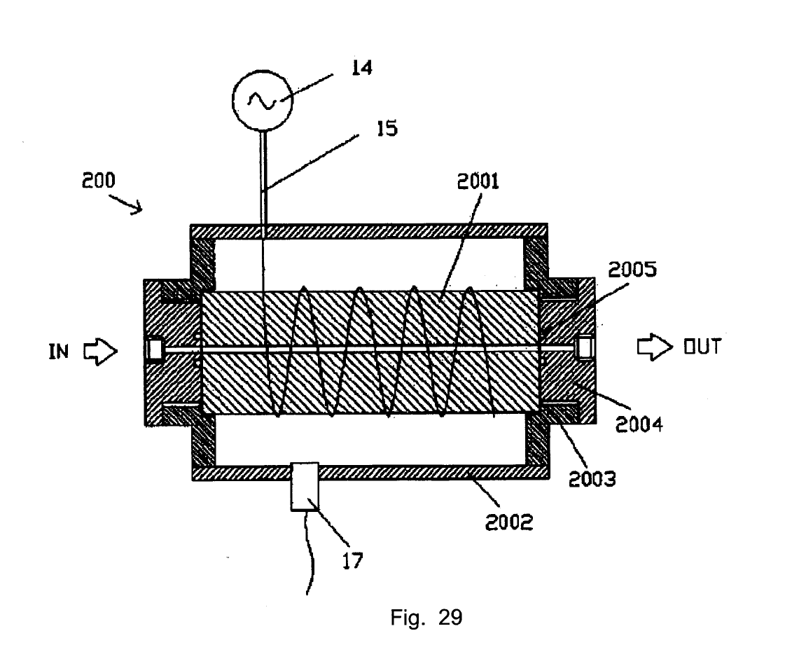

FIG. 29 shows a high pressure heating system 200. A high pressure vessel 2001 of the high pressure heating system 200 can be made of any microwave transparent or semi-transparent material with high mechanical strength such as glass, sapphire, AlO₃, etc. The applicator is constructed in this embodiment to withstand pressures from 2 MPa to 500 MPa. The system 200 is held together by the enclosure 2002, the end structure 2003 and the end pieces 2004. A high pressure seal 2005 is placed between the end pieces and the high pressure reaction vessel. The enclosure 2002, end structure 2003 and end pieces 2004 form a non-resonant enclosure. The enclosure 2002 and the end structure 2003 can be, for example, welded or threaded together. The end pieces 2004 and the end structure 2003 when threaded together provide a structure that is dissembled more easily. The temperature measuring device 17 can be mounted in the enclosure. It should be noted that the reaction mixture is pumped through the system with any type of high pressure pump (not shown).

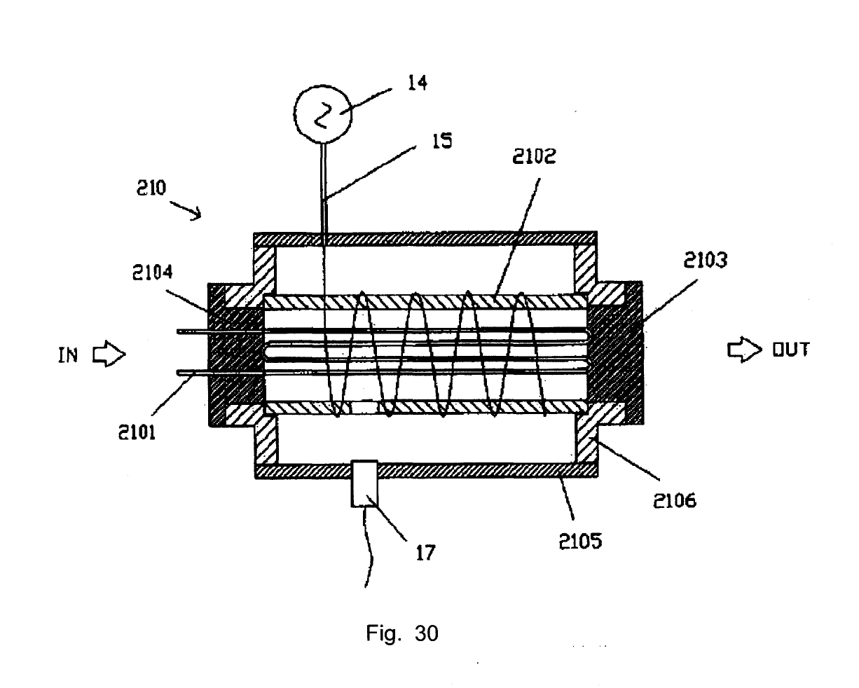

FIG. 30 shows a microwave heating system 210 with a capillary reaction vessel. End pieces 2103 and 2104 support a reaction vessel 2101 inside the supporting structure 2102. The enclosure 2105 and the end structure 2106 together with the end pieces 2103 and 2104 forming a non-resonant enclosure.

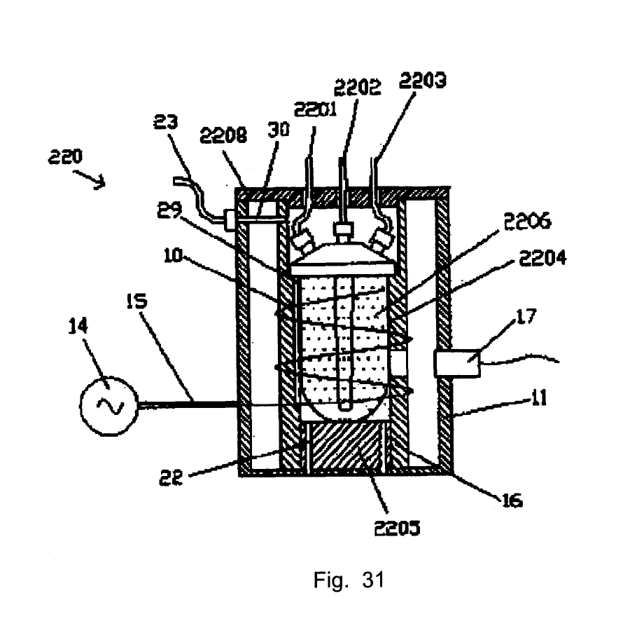

FIG. 31 shows a microwave heating system 220 with a 3-port reaction vessel. The reaction vessel 2004 has three connections 2201, 2202 and 2203 that can be used as inlets or outlets to add and/or remove material/reaction mixture 2206 from the reaction vessel 2204. For example, one port can be used to add reagents during a chemical process or subtract parts of a reaction mixture for analysis of the reaction mixture. The reaction vessel 2204 can be used either as a flow through reaction cell or a batch reaction vessel where the flow is stopped during the chemical process. The lid 2208 and the enclosure 11 form a non-resonant enclosure. The supporting structure 2205 and 16 support the reaction vessel 2204 and have air channels 22 and 29 to guide the cooling air.

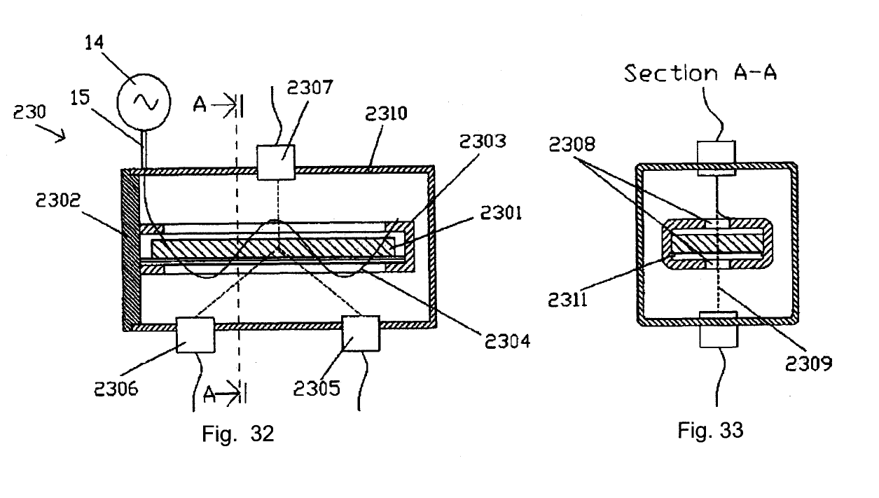

FIGS. 32 and 33 show a microwave heating system 230 that may be used for analytical purposes in, for example, environmental applications, diagnostic applications, forensic applications, identification and quantification of biomarkers, etc. In FIG. 32, a sample 2301 to be analyzed is inserted into a supporting structure 2303 that has a slot or ridge 2311 to hold the sample in position. The supporting structure 2303 includes openings 2308 for the analytical devices 2305, 2306 and 2307 to gain access to the sample 2301. The analytical devices 2305, 2306 and 2307 can be of any type that can perform an analytical operation. Example of devices include, but are not limited to optical devices to detect emission of a specific wavelength or a spectrum, devices to stimulate emission from the sample like lasers or other energy sources, etc. As an example, and as indicated by the dotted line 2309, the wave from a device 2307 can be detected by the two other devices 2306 and 2305 after having passed through the microwave irradiated sample 2301 and thereby gaining analytical information about the sample. The devices 2305, 2306 and/or 2307 can be moved into any position along the enclosure 2310. The devices 2305, 2306 and 2307 can be any type of, for example, transmitters and/or receivers to gain analytical information from the analyzed sample 2301. Vision systems and any type of microscopes can be part of the system 230. FIG. 33 shows a section through the system 230. The sample 2301 to be analyzed can be of any type, for example, organic or non-organic, tissues, liquids, solids etc. The lid 2302 and the enclosure 2310 form a non-resonant enclosure. The enclosure can be pressure tight and filled partly or completely with liquid or gas.

Thus, various embodiments provide a microwave heating system having a helical antenna surrounding a load within a non-resonant enclosure. The antenna is formed from a single ended continuous coil or a balanced coil wherein the electric field is mainly propagated inward toward the load. The microwave heating according to the various embodiments provides uniform energy distribution within the antenna structure.

The various embodiments and/or components, for example, the processors for generating microwaves or components and controllers therein, also may be implemented as part of one or more computers or processors that may form part of a larger system. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. For example, the ordering of steps recited in a method need not be performed in a particular order unless explicitly stated or implicitly required (e.g., one step requires the results or a product of a previous step to be available). While the dimensions and types of materials described herein are intended to define the parameters of the invention, they are by no means limiting and are exemplary embodiments. Many other embodiments will be apparent to those of skill in the art upon reviewing and understanding the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A microwave heating system comprising:
a non-resonant enclosure; and
a continuous helical antenna within the non-resonant enclosure, the continuous helical antenna configured to receive therein a load to be heated by microwaves radiated from the continuous helical antenna.

2. A microwave heating system in accordance with claim 1 wherein the continuous helical antenna comprises an open single ended antenna.

3. A microwave heating system in accordance with claim 1 wherein the continuous helical antenna comprises a closed loop single ended antenna.

4. A microwave heating system in accordance with claim 1 wherein the continuous helical antenna comprises an open balanced antenna.

5. A microwave heating system in accordance with claim 1 wherein the continuous helical antenna comprises a closed loop balanced antenna.

6. A microwave heating system in accordance with claim 1 wherein the continuous helical antenna comprises a resonant antenna.

7. A microwave heating system in accordance with claim 1 wherein the non-resonant enclosure has a cylindrical profile.

8. A microwave heating system in accordance with claim 1 wherein the non-resonant enclosure has a non-cylindrical profile.

9. A microwave heating system in accordance with claim 1 further comprising a coil forming the continuous helical antenna and wherein the coil comprises at least one turn.

10. A microwave heating system in accordance with claim 1 further comprising a coil forming the continuous helical antenna and wherein the coil comprises less than one turn.

11. A microwave heating system in accordance with claim 1 wherein the non-resonant enclosure comprises at least one of a conducting and semiconducting material.

12. A microwave heating system in accordance with claim 1 wherein the non-resonant enclosure is configured dimensionally to prevent microwaves from propagating therein.

13. A microwave heating system in accordance with claim 1 further comprising a coil forming the continuous helical antenna and wherein an unwound length of the antenna is less than one wavelength.

14. A microwave heating system in accordance with claim 1 further comprising a coil forming the continuous helical antenna and wherein an unwound length of the coil is greater than or equal to one wavelength.

15. A microwave heating system in accordance with claim 1 wherein a diameter of a coil structure that forms the continuous helical antenna varies over a length of the coil structure.

16. A microwave heating system in accordance with claim 1 further comprising a reaction vial and wherein the continuous helical antenna receives the reaction vial therein.

17. A microwave heating system in accordance with claim 1 wherein the load comprises a reaction mixture.

18. A microwave heating system in accordance with claim 1 wherein the load comprises a reaction mixture for producing a radiopharmaceutical.

19. A microwave heating system in accordance with claim 1 wherein the load comprises a stationary load.

20. A microwave heating system in accordance with claim 1 further comprising a flow reactor and wherein the load comprises a moving load.

21. A microwave heating system in accordance with claim 1 further comprising a supporting structure in combination with the continuous helical antenna for maintaining the load within the continuous helical antenna.

22. A microwave heating system in accordance with claim 21 wherein the supporting structure comprises at least one of a microwave transparent material and a partially microwave transparent material.

23. A microwave heating system in accordance with claim 21 wherein the supporting structure contains one of a liquid or a gas.

24. A microwave heating system in accordance with claim 21 wherein the supporting structure comprises at least one inlet and at least one outlet.

25. A microwave heating system in accordance with claim 1 further comprising a load holder configured to receive therein the load.

26. A microwave heating system in accordance with claim 25 wherein the load holder comprise one of a reaction vial, a bulb, a tube, a capillary structure, a thin film substrate, a glass slab, a microscope slide, a micro titer plate, a micro fluidic device, a micro array and a micro fabricated structure.

27. A microwave heating system in accordance with claim 1 wherein the load comprises one of a glass slab and a film.

28. A microwave heating system in accordance with claim 1 further comprising a tuning device connected to the continuous helical antenna to change resonance properties of the continuous helical antenna.

29. A microwave heating system in accordance with claim 28 wherein at least one of a resistance, inductance and capacitance of the tuning device can be changed.

30. A microwave heating system in accordance with claim 28 further comprising a monitoring device providing a feedback signal to the tuning device that is used to tune the continuous helical antenna.

31. A microwave heating system in accordance with claim 30 wherein the monitoring device comprises one of a temperature sensor, a pressure sensor, an ultraviolet (UV) sensor, an infrared (IR), an x-ray device, an ultrasound device, a laser, a fluorescence measuring device, a chemoluminescence measuring device and a spectroscopy device.

32. A microwave heating system in accordance with claim 1 further comprising a controller to control a frequency of the microwaves.

33. A microwave heating system in accordance with claim 32 wherein the controller comprises one of a finite state machine and a feedback machine.

34. A microwave heating system in accordance with claim 1 wherein the continuous helical antenna is configured to receive therein a load to be heated by microwaves to perform one of preparation, production, analytical analysis and diagnosis.

35. A microwave heating system comprising:
a non-resonant enclosure; and
a resonant antenna within the enclosure formed from a single continuous coil, the single continuous coil having a length greater than a diameter thereof.

36. A microwave heating system in accordance with claim 35 wherein the single continuous coil is helical in shape to receive therein a cylindrical member for heating a load therein using microwaves.

37. A microwave heating system in accordance with claim 35 wherein the non-resonant enclosure is dimensioned to provide a cutoff frequency that does not propagate electromagnetic energy.

38. A method for heating a load with microwaves, the method comprising:
forming a continuous coil in a toroidal shape to define an antenna for generating an electromagnetic field therein; and
configuring the continuous coil to generate the electromagnetic field within a non-resonant structure to heat a load using microwaves.

39. A method in accordance with claim 38 wherein the load comprises a Positron Emission Tomography (PET) material.

40. A method in accordance with claim 38 wherein at least one of a frequency and a power of the microwaves is varied to control a reaction in the load.
